(19) United States
(12) Patent Application Publication
(10) Pub. No.: US 2014/0344506 A1
(43) Pub. Date: Nov. 20, 2014

(54) ELECTRONIC DEVICE WITH WRITING PROTECTION AND RELATED METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: Ya-Guo WANG, Shenzhen (CN); Chun-Ching CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/244,092

(22) Filed: Apr. 3, 2014

(30) Foreign Application Priority Data
May 16, 2013 (CN) 2013101808919

(51) Int. Cl. G06F 3/06; G06F 13/24; G06F 12/02

(52) U.S. Cl. CPC G06F 3/0656; G06F 12/0246; G06F 13/24; G06F 3/0604; G06F 3/0683; G06F 2212/7203; G06F 2003/0691
USPC 711/103; 711/154; 711/104

(57) ABSTRACT

An electronic device comprises a buffer, a processing module, and a storage. When the electronic device generates a writing instruction, the processing module executes a protection and writes data of the buffer into the storage. Based on the protection, the processing module fails to execute interrupt instructions while writing data into the storage.

### FIELD

The present disclosure relates to electronic devices, particularly to an electronic device with writing protection.

### BACKGROUND

Electronic devices, such as computers or mobile phone, include a processor and storage for storing data. The processor executes a writing process for storing data into the storage in response to a writing instruction. However, when an interrupt instruction and the writing instruction occur simultaneously, the processor will execute the interrupt instruction. Thus an error may occur while writing data into the storage, and the electronic device may work in an abnormal state.

Therefore, there is room for improvement in the art.

### BRIEF DESCRIPTION OF THE FIGURES

Many aspects of the embodiments can be better understood with reference to the following drawings. The components in the drawings are not necessarily drawn to scale, the emphasis instead being placed upon clearly illustrating the principles of the electronic device and writing protection method thereof. Moreover, in the drawings, like reference numerals designate corresponding parts throughout the views.

FIG. 1 is a block diagram of an embodiment of an electronic device.

FIG. 2 is a flowchart of an embodiment of a writing protection method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

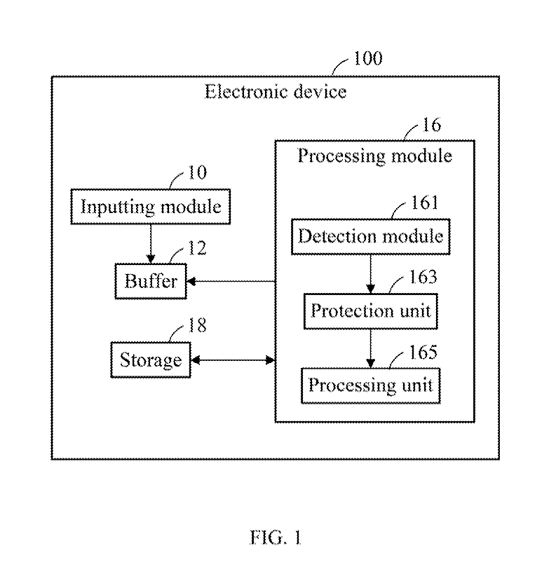

FIG. 1 shows an embodiment of an electronic device 100. The electronic device 100 prevents a writing process from being interrupted by interrupt instructions.

The electronic device 100 includes an inputting module 10, a buffer 12, a processing module 16, and a storage 18.

The inputting module 10 is used for generating different instructions and data based on operations of a user. The instructions include a writing instruction and interrupt instructions. The interrupt instructions can be a timer interrupt instruction or an external interrupt instruction. In one embodiment, the inputting module 10 can be a keyboard, a touch panel, a remote controller, or other suitable input device.

The buffer 12 is connected to the inputting module 10. The buffer 12 is used for transiently storing data. In one embodiment, the buffer 12 is a random access memory.

The processing module 16 is connected between the buffer 12 and the storage 18. The processing module 16 processes data and executes applications, and shields interrupt instructions while writing data stored from the buffer 12 into the storage 18. The processing module 16 includes a detection unit 161, a protection unit 163, and a processing unit 165.

The detection unit 161 determines whether there are data in the buffer 12 required to be stored into the storage 18. When there are data in the buffer 12 required to be stored into the storage 18, the detection unit 161 generates a protecting signal.

The protection unit 163 is connected to the detection unit 163. The protection unit 163 executes a protection for shielding interrupt instructions and generates a writing instruction in response to the protecting signal. Thus, processing unit 165 fails to execute the interrupt instructions while writing data into the storage 18.

The processing unit 165 is connected to the protection unit 163. The processing unit 165 writes the data stored in the buffer 12 into the storage 18 in response to the writing instruction. The processing unit 165 further generates and sends a stop signal to the protection unit 163 when the data are completely stored in the storage 18.

The storage 18 is used for storing data. In one embodiment, the storage 18 is an electrically erasable programmable read-only memory.

The protection unit 163 stops executing the protection in response to the stop signal. Thus, the processing unit 165 can receive the interrupt instructions.

For example, when adjusting a value of the volume of the electronic device 100 to 15 dB, the inputting module 10 generates an adjusting instruction based on the adjustment of the volume, and a volume value is transiently stored in the buffer 12. The detection unit 161 determines that the value of the volume is required to be stored into the storage 18 and generates a protecting signal. The protection unit 163 executes the protection in response to the protecting signal. When the electronic device 100 generates interrupt instructions, such as an interrupt instruction generated in a power-off operation of the electronic device 100, while the protection is executed by the protection unit 163, the interrupt instruction is shielded by the protection unit 163, and the processing unit 165 fails to execute the interrupt instruction while writing the volume data into the storage 18.

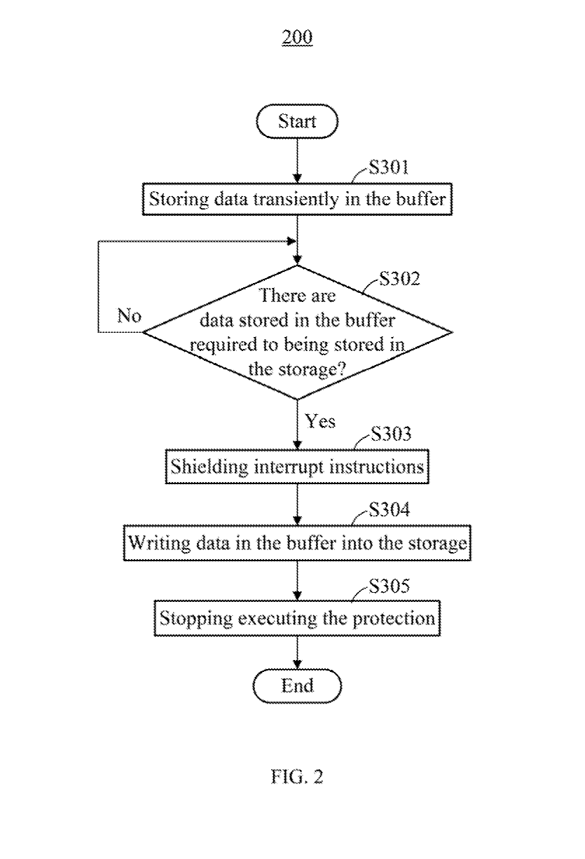

FIG. 2 shows a writing protection method 200 applied to an electronic device 100 The method includes the following steps.

In step S301, the buffer 12 transiently stores data. In one embodiment, the buffer 12 is a random access memory.

In step S302, the detection unit 161 determines whether there are data in the buffer 12 required to be stored into the storage 18. If there are data in the buffer 12 required to be stored into the storage 18, the detection unit 161 generates a protecting signal, and the procedure goes to S303. If there is no data in the buffer 12 required to be stored into the storage 18, the procedure goes back to S301.

In step S303, in response to the protecting signal, the protection unit 163 executes a protection for shielding interrupt instructions and generates a writing instruction. Furthermore, the processing unit 165 fails to execute interrupt instructions while writing data into the storage 18.

In step S304, in response to the writing signal, the processing unit 165 writes data stored in the buffer 12 into the storage 18 and generates a stop instruction when the data are completely stored into the storage 18. In one embodiment, the storage 12 is an electrically erasable programmable read-only memory.

In step S305, in response to the stop signal, the protection unit 163 stops executing the protection.

In use, while the processing module 16 writes data into the storage 18, the interrupt instructions generated are shielded from interrupting the writing of the data into the storage 18. Thus, data storage is improved.

While various embodiments have been described, the disclosure is not to be limited thereto. Various modifications and similar arrangements (as would be apparent to those skilled in the art) are also intended to fall within this disclosure. The scope of the appended claims should be accorded the broadest interpretation so as to encompass at least all such modifications and similar arrangements.

What is claimed is:

1. An electronic device capable of generating different instructions, the electronic device comprising:
a buffer for transiently storing data;
a processing module connected to the buffer; and
a storage connected to the processing module;
wherein when a writing instruction is generated, the processing executes a protection and writes data of the buffer into the storage; base on the protection, the processing module fails to execute interrupt instructions while writing data into the storage.

2. The electronic device of claim 1, wherein the processing module further stops executing the protection after completely stored the data into the storage.

3. The electronic device of claim 1, wherein the processing module comprises a detection unit, a protection unit, and a processing unit; the detection unit determines whether there are data in the buffer required to be stored into the storage; when there are data in the buffer required to be stored into the storage, the detection unit generates a protecting signal; the protecting executes the protection and generates a writing instruction; the processing unit writes data of the buffer into the storage.

4. The electronic device of claim 3, wherein when the data of the buffer is completely stored the data in the storage, the processing unit further generates a stop signal; the protection unit stops executing the protection for enabling the processing unit to execute interrupt instructions in response to the stop signal.

5. The electronic device of claim 1, wherein the buffer comprises a random access memory.

6. The electronic device of claim 1, wherein the storage comprises an electrically erasable programmable read-only memory.

7. A writing protection method applied to an electronic device with a buffer and a storage; the writing protecting method comprising:
storing data in the buffer;
determining whether there are data in the buffer required to be stored into the storage;
shielding interrupt instructions; and
writing data in the buffer into the storage.

8. The writing protection method of claim 7, further comprising:
stopping executing the protection after the data is completely stored into the storage.

9. The method of claim 7, wherein the buffer comprises a random access memory.

10. The method of claim 7, wherein the storage comprises an electrically erasable programmable read-only memory.
